(19) United States
(12) Patent Application Publication
(10) Pub. No.: US 2007/0182967 A1
(43) Pub. Date: Aug. 9, 2007

(54) Method and apparatus for precision measurement of phase shifts

(75) Inventors: Andrew Gerard White, Taringa (AU); Michael David Harvey, Indooroopilly (AU)

Correspondence Address: Monique A Morneault;Wallenstein Wagner & Rockey, 311 South Wacker Drive-5300, Chicago, IN, 60606, US

(73) Assignee: THE UNIVERSITY OF QUEENSLAND, St Lucia (AU)

(21) Appl. No.: 10/568,657

(22) PCT Filed: Aug. 27, 2004
(86) PCT No.: PCT/AU04/01160

§ 371 Date: Oct. 26, 2006

(30) Foreign Application Priority Data
Aug. 27, 2003 (AU) 2003904613

(51) Int. Cl. G01B 9/02

(52) U.S. Cl. 356/491

(57) ABSTRACT

An interferometer (1) includes a beam displacing assembly (5, 9). The beam displacing assembly is arranged to split an input beam (4) into first and second basis beams (6, 8), that have orthogonal polarisations being respective horizontal and vertical polarizations, and to combine said basis beams to produce an output beam (12). A polarimetric phase retrieval assembly (11) is responsive to the output beam and is arranged to determine a difference in phase shift imparted to one of the basis beams (6, 7) relative to the other by a test piece (7). Other embodiments of the invention are arranged to produce basis beams that have respectively orthogonal spatial modes.

### FIELD OF THE INVENTION

The present invention relates to a method and apparatus for measurement of electromagnetic phase shifts. In a particular application the invention provides an inherently stable and robust interferometer.

### BACKGROUND TO THE INVENTION

Phase measurement by interferometry is at the heart of a wide range of diagnostic methods. A non-exhaustive list of applications includes spectroscopy, microscopy, gas analysis, flow analysis, pollution monitoring, monitoring thin-film deposition and stress analysis and distance measurement.

Several different types of two-beam interferometers are known in the prior art. Typical examples are the Michelson, Mach-Zehnder and Jamin interferometers. In general these apparatus operate by amplitude division, that is dividing an incident laser beam into two beams, one of which is used as a reference beam and the other which is used as a probe beam. The optical path of the probe beam is varied relative to the reference beam by its passage through, or reflection from, a test piece. The beams are recombined and interfere. The intensities of the interference fringes in the output beams are sinusoidal functions of the optical path difference introduced by interaction of the probe beam with the test piece.

A problem that arises in the use of some types of prior art interferometers is that their operation is impaired by shocks and vibration.

It is an object of the present invention to provide an alternative to prior art interferometers that is robust and relatively insensitive to shock and vibration.

### SUMMARY OF THE INVENTION

According to a first aspect of the present invention there is provided an interferometer including:

a beam displacing assembly arranged to split an input beam into separated first and second basis beams and to combine said basis beams to produce at least one output beam; and

a phase analyser responsive to the at least one output beam and arranged to determine a difference in phase shift imparted to one of said basis beams relative to the other by a test piece.

In one embodiment the beam displacing assembly includes first and second polarising beam displacers.

The second polarising beam displacer may be orientated inversely relative to the first polarising beam displacer.

Preferably a half-wave plate is located between the first and second polarising beam displacers.

The phase analyser may comprise a polarimetric phase retrieval assembly arranged to calculate the phase shift on the basis of signals representing Stokes parameters associated with the output beam.

In one embodiment the beam displacing assembly is arranged to impart horizontal and vertical polarizations to the first and second basis beams.

Preferably the phase analyser comprises a polarimetric phase retrieval assembly including half-wave and quarter wave plates to transform left and right circular components of the at least one output beam into corresponding vertical and horizontal components.

Preferably the interferometer includes means to discriminate between the vertical and horizontal components.

In a preferred embodiment photodetectors are included to produce electrical signals corresponding to the vertical and horizontal components.

The interferometer may include means to combine the electrical signals to produce signals corresponding to Stokes parameters.

Preferably a processor is provided that is responsive to the signals corresponding to the Stokes parameters and arranged to generate a signal indicating a phase shift imparted to one of the basis beams relative to the other.

The beam displacing assembly may include a beam splitter arranged to split the input beam into the separated first and second basis beams

In one embodiment the interferometer includes first and second holographic plates arranged to impart respectively orthogonal spatial modes to said first and second basis beams.

Preferably the interferometer includes a means to superpose the first and second basis beams thereby creating said at least one output beam.

The means to superpose the first and second basis beams may comprise a beamsplitter.

Alternatively, the means to superpose the first and second basis beams may comprise a holographic plate.

In one embodiment the means to superpose the first and second basis beams produces first and second output beams comprising a superposition of transverse spatial modes.

In one embodiment the phase analyser includes a number of spatial mode analysers each including a means to convert a desired one of said transverse spatial modes to a lowest order spatial mode.

Preferably the means to convert one of said transverse spatial modes to a lowest order spatial mode comprises a holographic plate.

Preferably the spatial mode analysers each include a spatial mode filter arranged to filter light from the holographic plate.

The spatial mode filter may comprise a single mode optical fibre.

Preferably light from said optical fibre is converted to a corresponding electrical signal by means of a photodetector.

It is desirable that the interferometer include means to combine corresponding electrical signals from each of the number of spatial mode analysers in order to obtain signals representing Stokes parameters.

Preferably a processor is provided that is arranged to process the signals representing Stokes parameters in order to generate a signal corresponding to a phase shift imparted to one of said basis beams relative to the other.

According to a further aspect of the present invention an interferometer is provided that includes:

means for splitting an input beam into a first pair of basis beams;

means for recombining said first pair of basis beams to form at least one output beam; and

means for processing the at least one output beam to determine a relative phase shift imparted between the said first pair of basis beams.

The means for splitting the input beam may be arranged so that the first pair of basis beams comprises respective orthogonally polarized beams.

More particularly, the means for splitting the input beam may be arranged so that the first pair of basis beams comprises respective horizontally and vertically polarized beams.

Preferably the means for processing the at least one output beam comprises a polarimetric phase retrieval assembly.

Alternatively, the means for splitting the input beam is arranged so that the first pair of basis beams comprises respective orthogonal spatial mode beams. In that case the means for processing the at least one output beams may include a number of spatial mode filters

The polarimetric phase retrieval assembly will preferably be arranged to calculate the phase shift from signals representing Stokes parameters.

Further preferred features of the present invention will be described in the following detailed description of exemplary embodiments wherein reference will be made to a number of figures as follows.

### BRIEF DESCRIPTION OF THE DRAWINGS

FIG. 1 is a block diagram of an interferometer according to a preferred embodiment of the invention.

FIG. 2 is a block diagram of an interferometer according to a further embodiment of the invention.

FIG. 3 is a block diagram of an interferometer according to another embodiment of the invention.

FIG. 4 is a block diagram of polarimetric phase retrieval module according to a preferred embodiment of the invention.

FIG. 5 is a block diagram of an interferometer according to a further embodiment of the invention.

FIG. 6 is a block diagram of a spatial mode analyser used in the interferometer of FIG. 5.

### DETAILED DESCRIPTION OF EXEMPLARY EMBODIMENTS

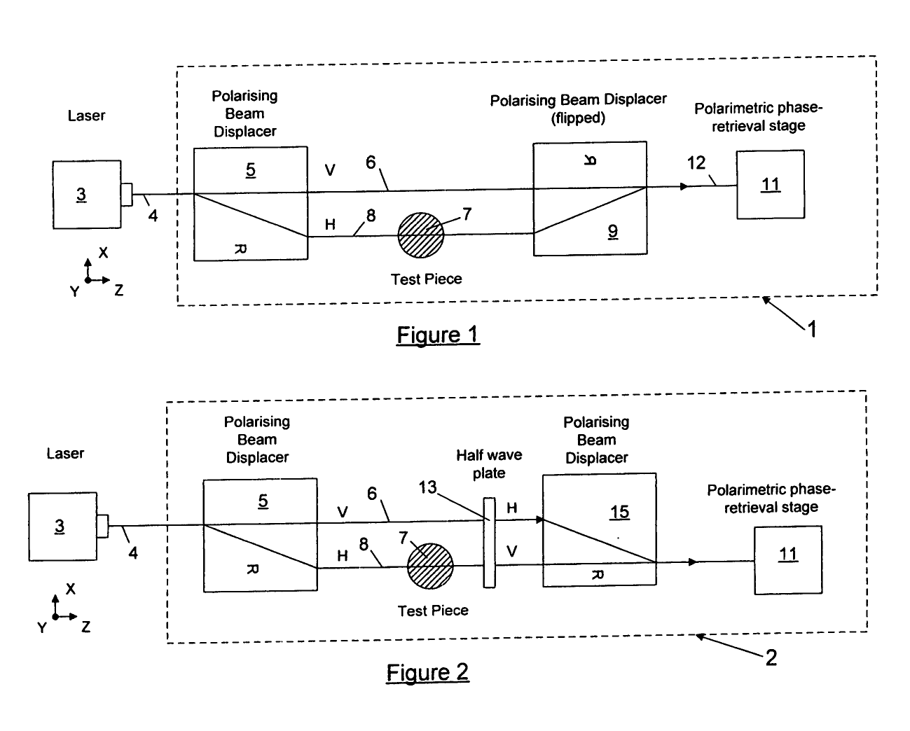

A preferred embodiment of an interferometer 1, according to the present invention, is shown schematically in FIG. 1. Interferometer 1 includes a beam displacing assembly comprised of polarising beam displacer 5 and inversely orientated beam displacer 9. Polarising beam displacer 5 is arranged to receive an input beam of light 4, having a known polarisation state, from laser 3. In the embodiment of FIG. 1, input beam 4 is coherently split into a pair of basis beams in the form of a vertically polarised reference beam 6 and a horizontally polarised probe beam 8.

In use a test piece 7 is placed in the path of probe beam 8 as shown. Phase shift is imparted to the probe beam due to its interaction with the piece. Reference beam 6 and probe beam 8 are recombined by polarising beam displacer, 9, orientated inversely relative to displacer 5, to form an encoded output beam 12. Output beam 12 is received by a phase shift analyser in the form of polarimetric phase-retrieval module 11. Phase-retrieval module 11 generates an electrical signal that corresponds to the phase shift imparted by test piece 7.

FIG. 2 is a block diagram of a further embodiment of an interferometer 2 according to the present invention wherein the probe and reference beam paths are interferometrically balanced via the addition of a suitably orientated polarising control. In the embodiment of FIG. 2 the polarising control comprises a half-wave plate 13 with its optic axis at 45°, and with the output beam displacer 15, having the same orientation as the input beam displacer 5.

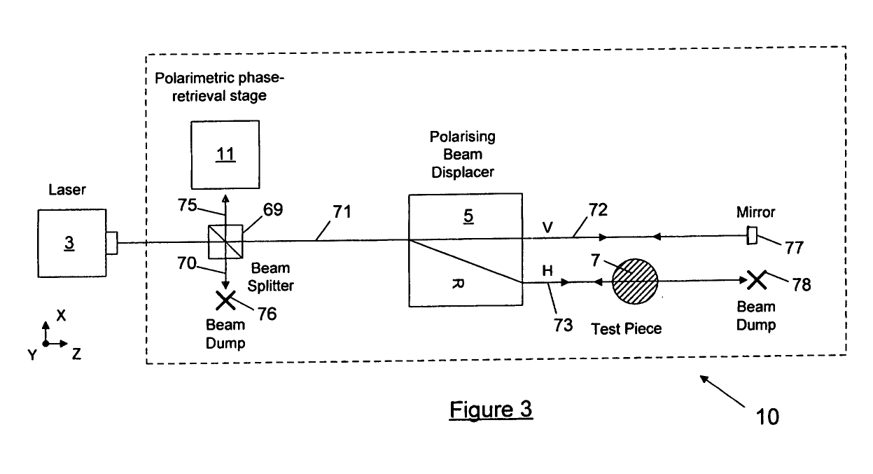

An interferometer 10, according to a further embodiment of the invention is shown in FIG. 3. Interferometer 10 is adapted to detect phase changes due to surface irregularities by reflection. In use, light from laser 3 is split at beam splitter 69 into beams 70 and 71. Beam 70 is discarded by directing it into beam dump 76. Beam 71 is split by beam displacer 5 into a pair of orthogonally polarized beams being vertically polarized beam 72 and horizontally polarized beam 73. Beam 72 is reflected by mirror 77 and acts as a retroflected reference beam. Beam 73 acts as a probe beam and is incident upon test piece 7. Some of probe beam 73 is reflected from test piece 7 and is recombined with the reflected reference beam 72 by beam displacer 5. Beam dump 78 serves to absorb any portion of probe beam 73 that is transmitted through test piece 7. The recombined beam is sent to beam splitter 69 where a portion of it is directed, as beam 75, to phase retrieval stage 11.

An advantage of the interferometers of FIGS. 1, 2 and 3 is that they are exceedingly stable as they are insensitive to relative displacements of the individual elements in the x, y and z directions. This stability is in contrast to Michelson, Mach-Zehnder, or Sagnac interferometers. Indeed, an interferometer according to an embodiment of the present invention may be configured to provide detection of extremely small rotations of, e.g. the second beam displacer 15 of FIG. 2. Similarly, test piece 7 may be composed of a system of physical elements. Varying phase shifts imparted by the test physical system, for example due to vibration, may then be monitored.

If the polarization state of beam 4 is not known, or if there are systemic phase shifts in a practical realisation of the device, then removing piece 7 facilitates interferometer calibration by providing a reference state, i.e. the state of output beam 12, that contains only systemic phase shifts.

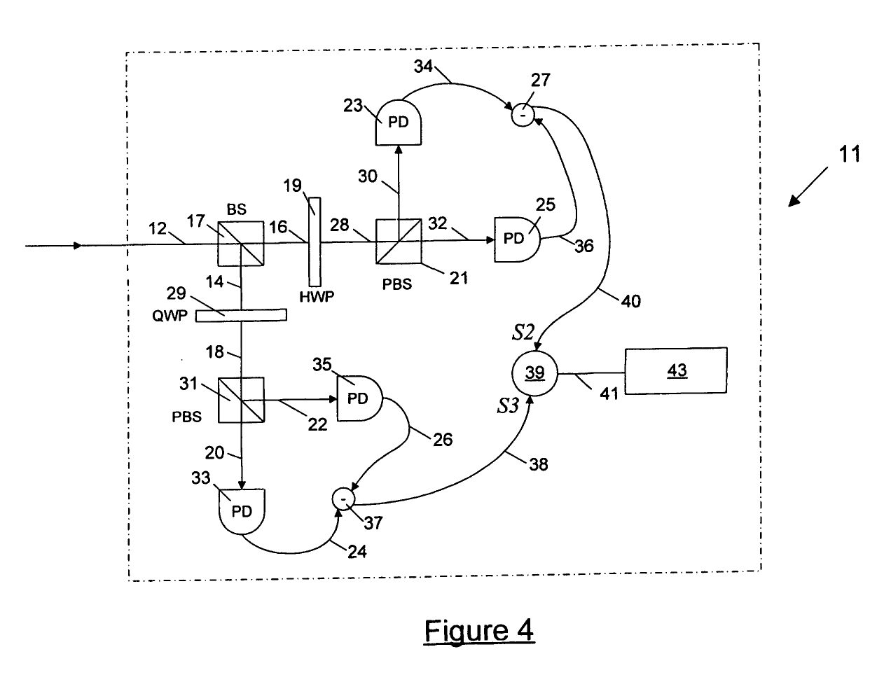

FIG. 4 shows one configuration of the internal components of polarimetric phase-retrieval assembly 11. Initially beam 12 is split in two by a 50-50 beam splitter 17 into beams 14 and 16. Quarter wave plate 29 transforms left and right circular components of beam 14 into corresponding vertical and horizontal components of beam 18. Accordingly, polarising beam-splitter 31 splits beam 18 into separate horizontally and vertically polarised component beams 20 and 22 respectively. The intensity of the horizontally polarised beam 20 is detected by photodetector 33 which produces a corresponding electrical signal on cable 24. The intensity of the vertically polarised beam 22 is detected by photodetector 35 which produces a corresponding electrical signal on cable 26. The intensity signals are appropriately scaled and differenced by pre-processor 37, for example a suitably configured operational amplifier, to produce a signal corresponding to the S3 Stokes parameter on cable 38.

Beam 16 from splitter 17 is incident upon a half wave plate 19 which transforms diagonal and anti-diagonal components in beam 16 into corresponding horizontal and vertical linearly polarized components of beam 28. Polarizing beam splitter 21 splits beam 28 into horizontally and vertically polarized component beams 32 and 30 respectively. The intensity of horizontally polarised beam 32 is detected by photodetector 25 to produce a corresponding electrical signal on cable 36. The intensity of the vertically polarised beam 30 is detected by photodetector 23 which produces a corresponding electrical signal on cable 34. The intensity signals on cables 36 and 34 are appropriately scaled and differenced by pre-processor 27 to produce a signal corresponding to the S2 Stokes parameter on cable 40.

The S2 and S3 signals from pre-processors 27 and 37 are processed by processing module 39 to calculate φ=arctan(S3/S2) which is the phase difference imparted by piece 7. In one implementation, processing module 39 includes a suitably programmed fast digital processor and associated analog-to-digital converters to calculate the arctangent function. The processing module may also control a digital display 43, by means of cable 41, in order to generate a visual readout of φ.

The S₂ and S₃ detectors may be configured to measure the temporal variation in the output, the spatial variation in the output, or both. That is, the photodetection part of the detectors may include, but are not limited to, single element detectors (for example, PIN photodiode or PMT) or spatial imaging components (for example, CCD or CMOS camera). In the latter case, the signal processing must be applied on a pixel by pixel basis.

It will be realised that the present invention involves, decomposing the output beam 12 into a pair of analysis beams that are analysed in bases different to that used to construct the input. Each component in the new bases can be expressed as a linear superposition of components of the original basis, beams 6 and 8, with a known relationship between them. Thus this relationship may be used to extract the relative phase shift between the reference and probe arms. This is then, exactly, the phase shift imparted to electromagnetic radiation by the physical system under study. Those skilled in the art will appreciate that equivalent behaviour can be realised with any two orthogonal modes, e.g. orthogonal transverse spatial modes of the field, and a phase extracted from them by an appropriate homologue of the Stokes parameters (see for example N. K. Langford et al., Physical Review Letters vol. 93, 053601 (2004), the contents of which is hereby incorporated in its entirety by cross-reference).

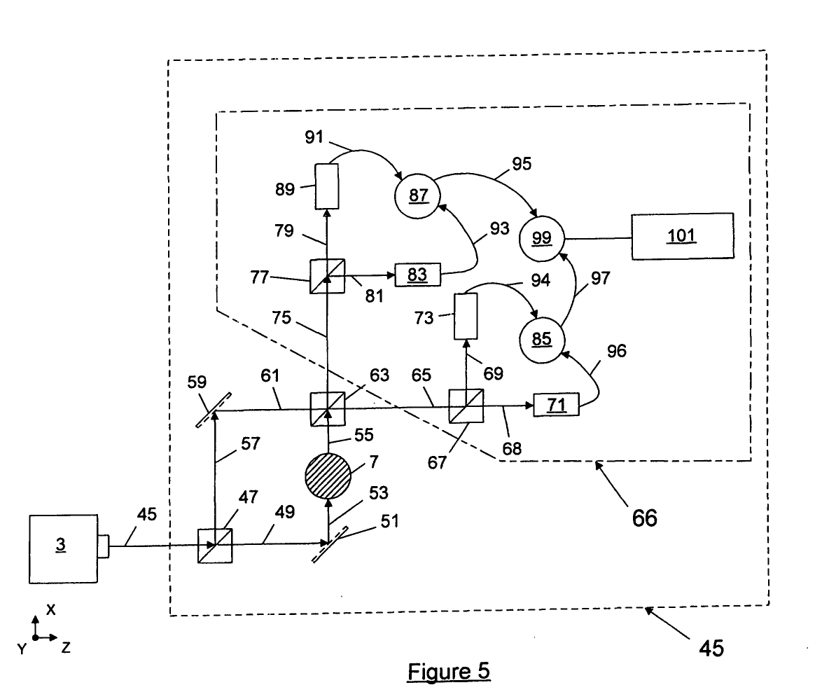

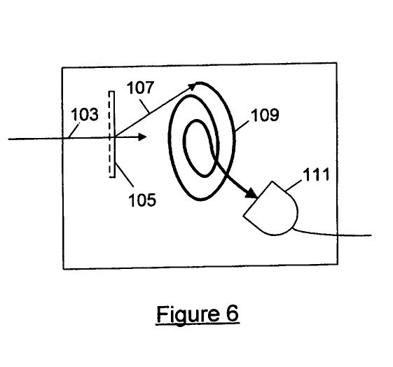

An embodiment of the invention which makes use of orthogonal spatial modes is depicted in use in FIG. 5. With reference to that Figure, beam 45 from laser 3 is incident on a beam splitter 47 which splits the beam into beams 49 and 57. Beam 49 is incident on hologram 51 which converts beam 49 into a different transverse spatial mode beam 53. Beam 53 then passes through test piece 7 which imparts a phase shift to resulting beam 55. Similarly, beam 57 is incident on hologram 59 which converts the beam into beam 61. Beam 61 is in a transverse spatial mode orthogonal to that of beam 55. Beams 55 and 61 are superposed on element 63 which may be a beam splitter or hologram as appropriate to form superposed output beams 75 and 65. Superposed beams 75 and 65 are sent to beam splatters 77 and 67 of phase analyser 66. The resulting four beams 79, 81, 69 and 68 are analysed by spatial mode analysers 89, 83, 73 and 71 respectively. The structure of the spatial mode analysers is shown in FIG. 6 and will be described shortly. The output of the spatial mode analysers comprises four electrical signals which are conveyed by cables 91, 93, 94 and 96 respectively. Circuits 87 and 85 are connected to cables 91, 93 and 94, 96 respectively and are arranged to process the signals from the spatial mode analysers to generate signals representing Stokes parameters on cables 95 and 97. Processing unit 99 operates upon the signals from circuits 87 and 85 to recover the phase shift imparted by test piece 7. The phase shift is then displayed on display unit 101.

Referring now to FIG. 6, there is depicted a block diagram of a spatial mode analyser of the same type as spatial mode analysers 89, 83, 73 and 71. In operation an incident beam 103, containing a superposition of transverse spatial modes, is incident upon a hologram 105. Hologram 105 is selected to convert a desired transverse spatial mode of beam 103 to a beam of light 107 having a corresponding lowest order spatial mode. Light beam 107 is then passed through a spatial mode filter 109. In the present example filter 109 is provided in the form of a single mode optical fibre. The output from filter 109 is detected by photodetector 111 which produces a corresponding electrical signal. Filter 109 rejects all other transverse spatial modes as explained in the previously mentioned article by N. K. Langford et al.

Referring again to FIGS. 1, 2 and 3, the beam displacers shown in those figures are relatively insensitive to changes in wavelength over a broad range. Thus an interferometer according to an embodiment of the present invention may be used to measure phase shifts of multiple wavelengths simultaneously. For example, input beam 4 might include a fundamental frequency and its second harmonic, a mixture of several laser lines or the output from a number of lasers. Alternatively it could comprise a frequency comb, for example a “white-light” comb produced by photonic band gap materials. The output may be first separated into wavelength components and then phase analysed with S2 and S3 detectors, or more practically, first split into S2 and S3 detector arms which incorporate broadband polarisation optics, and then wavelength analysed, before the photodetection element. Cellophane may be used to implement a satisfactory broadband waveplate.

Further variations and embodiments in addition to those explained herein are possible, for example, the output beams of beam displacer 5 in the embodiments of FIGS. 1 and 2 can be directed through appropriate polarisation rotation elements to a retroreflecting element. Depending on the geometry of this element, the beams may then exit along the same path as they entered (similar to a Sagnac interferometer), or a separate path (similar to a displaced Sagnac interferometer). This configuration means that both beams experience the same distortions due to any imperfections in the first beam displacer.

The embodiments of the invention described herein are provided for purposes of explaining the principles thereof, and are not to be considered as limiting or restricting the invention since many modifications may be made by the exercise of skill in the art without departing from the scope of the invention as defined by the following claims.

1. An interferometer including:
a beam displacing assembly arranged to split an input beam into separated first and second basis beams and to combine said basis beams to produce at least one output beam; and
a phase analyser responsive to the at least one output beam and arranged to determine a difference in phase shift imparted to one of said basis beams relative to the other by a test piece.

2. An interferometer according to claim 1, wherein the beam displacing assembly includes first and second polarising beam displacers.

3. An interferometer according to claim 2, wherein the second polarising beam displacer is orientated inversely relative to the first polarising beam displacer.

4. An interferometer according to claim 2, wherein a half-wave plate is located between the first and second polarising beam displacers.

5. An interferometer according to claim 1 wherein the phase analyser comprises a polarimetric phase retrieval assembly arranged to calculate the phase shift on the basis of signals representing Stokes parameters associated with the output beam.

6. An interferometer according to claim 1, wherein the beam displacing assembly is arranged to impart horizontal and vertical polarizations to the first and second basis beams.

7. An interferometer according to claim 6, wherein the phase analyser comprises a polarimetric phase retrieval assembly including half-wave and quarter wave plates to transform left and right circular components of the at least one output beam into corresponding vertical and horizontal components.

8. An interferometer according to claim 7, including means to discriminate between the vertical and horizontal components.

9. An interferometer according to claim 8, including photodetectors to produce electrical signals corresponding to the vertical and horizontal components.

10. An interferometer according to claim 9, including means to combine the electrical signals to produce signals corresponding to Stokes parameters.

11. An interferometer according to claim 10, including a processor responsive to the signals corresponding to the Stokes parameters and arranged to generate a signal indicating a phase shift imparted to one of the basis beams relative to the other.

12. An interferometer according to claim 1, wherein the beam displacing assembly includes a beam splitter arranged to split the input beam into the separated first and second basis beams

13. An interferometer according to claim 12, including first and second holographic plates arranged to impart respectively orthogonal spatial modes to said first and second basis beams.

14. An interferometer according to claim 13, including a means to superpose the first and second basis beams thereby creating said at least one output beam.

15. An interferometer according to claim 14, wherein the means to superpose the first and second basis beams comprises a beamsplitter.

16. An interferometer according to claim 14, wherein the means to superpose the first and second basis beams comprises a holographic plate.

17. An interferometer according to claim 14, wherein the means to superpose the first and second basis beams produces first and second output beams comprising a superposition of transverse spatial modes.

18. An interferometer according to claim 17, wherein the phase analyser includes a number of spatial mode analysers each including a means to convert a desired one of said transverse spatial modes to a lowest order spatial mode.

19. An interferometer according to claim 18, wherein the means to convert one of said transverse spatial modes to a lowest order spatial mode comprises a holographic plate.

20. An interferometer according to claim 19, including a spatial mode filter arranged to filter light from the holographic plate.

21. An interferometer according to claim 20, wherein the spatial mode filter comprises a single mode optical fibre.

22. An interferometer according to claim 21, wherein light from said optical fibre is converted to a corresponding electrical signal by means of a photodetector.

23. An interferometer according to claim 22, including a means to combine corresponding electrical signals from each of the number of spatial mode analysers in order to obtain signals representing Stokes parameters.

24. An interferometer according to claim 23, including a processor arranged to process the signals representing Stokes parameters in order to generate a signal corresponding to a phase shift imparted to one of said basis beams relative to the other.

25. An interferometer including:
means for splitting an input beam into a first pair of basis beams;
means for recombining said first pair of basis beams to form at least one output beam; and
means for processing the at least one output beam to determine a relative phase shift imparted between the said first pair of basis beams.

26. An interferometer according to claim 25, wherein the means for splitting the input beam is arranged so that the first pair of basis beams comprises respective orthogonally polarized beams.

27. An interferometer according to claim 26, wherein the means for splitting the input beam is arranged so that the first pair of basis beams comprises respective horizontally and vertically polarized beams.

28. An interferometer according to claim 26, wherein the means for splitting the input beam is arranged so that the first pair of basis beams comprises respective orthogonal spatial mode beams.

29. An interferometer according to claim 27, wherein the means for processing the at least one output beam comprises a polarimetric phase retrieval assembly.

30. An interferometer according to claim 29, wherein the polarimetric phase retrieval assembly is arranged to calculate the phase shift from signals representing Stokes parameters.

31. An interferometer according to claim 28, wherein the means for processing the at least one output beam includes a number of spatial mode filters.
